(19) United States
(12) Patent Application Publication
(10) Pub. No.: US 2019/0016584 A1
(43) Pub. Date: Jan. 17, 2019

(54) FUEL PUMP

(71) Applicant: SPEED SOLUTIONS S.A.S, Medellín (CO)

(72) Inventors: Esteban LONDOÑO ORTIZ, Medellín (CO); Camilo Antonio LONDOÑO ORTIZ, Medellín (CO)

(73) Assignee: SPEED SOLUTIONS S.A.S, Medellín (CO)

(21) Appl. No.: 16/065,510

(22) PCT Filed: Dec. 20, 2016
(86) PCT No.: PCT/IB2016/057841

§ 371 Date: Jun. 22, 2018

(30) Foreign Application Priority Data
Dec. 24, 2015 (CO) 15306945

(51) Int. Cl. B67D 7/22; G07F 9/02; B67D 7/14; B67D 7/84; G07F 13/02

(52) U.S. Cl. CPC B67D 7/221; G07F 9/023; B67D 7/145; B67D 7/04; G07F 13/025; G07F 9/026; B67D 7/84

(57) ABSTRACT

Devices, means and arrangements used for the supply or dispatch of fuels for vehicles, including dispenser of fuel is described. There is a system of inventory control, receipt printing, fleet control with supply restrictions, storage in portable memories such as USB, electronic identification of seller, customer and vehicle, improved control system and management of fleets with storage of identifiers and generation of accurate and updated reports for delivery to the customer and respective collection of fuel, wireless communication with the control center to prevent data manipulation that may take place with having physical wiring, high durability and performance keyboard, and mainly with receipt formats that can be customized according to the needs and requirements of the customers.

### FIELD OF THE INVENTION

The present invention relates to the field of the devices, means and arrangements used for the supply or dispatch of fuels for vehicles, and more particularly it refers to a pump/dispenser of fuel for use in a fuel supply station, which has the functions common to any pump/dispenser of dispatch control, volume display and/or fuel price, etc., where the pump has a number of advantages over the stats of the art, which are mainly based on a system of inventory control, receipt printing, fleet control with supply restrictions, storage in portable memories such as USB, electronic identification of seller, customer and vehicle, improved control system and management of fleets with storage of identifiers and generation of accurate and updated reports for delivery to the customer and respective collection of fuel, wireless communication with the control center to prevent data manipulation that may take place with having physical wiring, high durability and performance keyboard, and mainly with receipt formats that can be customized according to the needs and requirements of the customers.

### DESCRIPTION OF THE PRIOR ART

To better understand the object and scope of the present invention it is convenient to describe the state of the art in reference to the disadvantages related to pumps or dispensers of fuel.

At present, fuel supply stations represent a widely used market, on a daily basis, since the vast majority of vehicles are of internal combustion, i.e., they require some fuel that must be supplied in a safe, adequate and mainly controlled manner. This supply is made through a series of fuel pumps, which normally have a handling of up to eight non-simultaneous dispatch units with their respective displays, measurement and display of dispatched product volume, display of the cash equivalence of the dispatched volume, display and configuration of the price per unit of volume, setting of volume or money quantity to be dispatched, communication with POS terminal by some type of adequate protocol being the Gilbarco protocol one of the most used and current loop, electronic and electromechanical totalizers of the total dispatched volume dispatched by each of the units, and finally printing of tickets or dispatch receipts.

Additionally, these fuel pumps which are commonly used today have a control center or room that allows constant monitoring of the device, in order to determine the amount of fuel that is supplied at a given time, while allowing having accurate and updated records of the operations carried out, a fact that is indispensable and required by the fuel supplier company to maintain constant control over its employees and its business in general.

Thus, in the state of the art there is a plurality of disclosures relating to fuel pumps, within which is document CN 200978222 which relates to a self-service multimedia fuel pump comprising a multimedia operation terminal, a microcomputer, a touch screen, a bar code scanner, a printer, a card reader, an IC card authentication module, a pump output control part, and a solenoid valve, a low sensor input control part and fuel hose switch signal, a safety system, a non-volatile memory and a real-time clock, wherein the two serial interfaces of the multimedia operation terminal are respectively connected to the communication ports of the bar code scanner and the SCM. Likewise, a parallel port connects to the printer, the touch screen is connected to a USB interface of the multimedia operation terminal, the card reader, the IC card authentication module, the output control of the pumps and the solenoid valves, the non-volatile memory and the clock are respectively connected to the corresponding port of the SCM.

However, the pump referred to in this priority has the disadvantage that it cannot be used for fleet management, i.e., when a single customer has a plurality of vehicles that require fuel supply, where it is necessary that control of fleet functions be performed manually or through a computerized system that includes software and an interface, which is a problem for the system administrator and for the fuel supplier company, due to the error that may occur by manual counting systems. Likewise, the pump described in the document does not have any type of sensor that can be used to control the temperature and other variables involved in the pump, which implies a imminent risk due to the type of flammable liquids involved, nor does it have the integration of level sensors that allow a direct knowledge of the inventory status of the tanks.

Now, another document related to this type of devices or systems is JP patent application 2012158345, which discloses a fuel pump which facilitates a registration operation and does not imply a risk of confusion to the consumer with normal use where the pump has a data logging keyboard for the initial configuration or modification of the pump configuration where this keyboard is arranged in a housing. The operation can be performed while maintaining an operation manual with one hand, therefore, the recording operation can be facilitated, while when no recording operation is performed, the keyboard is removed from the housing and therefore, there is no risk of confusion in the user. The data logging keyboard can be mounted on a board-like member with which a data logging component is covered. The data logging keyboard can be made from a keyboard sheet attached to a magnetic sheet or by printing the keyboard sheet on the magnetic sheet.

Thus, although the fuel pump disclosed in this document has a number of novel features useful in the field of fuel supply, such as the system for entering or registering data and the keyboard and its arrangement in the apparatus, it also has the disadvantage of not having any type of alert and control system or mechanism, as a sensor, while the communication relationship with the control room is very limited and can present faults without any backup, while not allowing the fuel supplier company to perform a fleet control which translates into a series of errors and therefore, loss of money in the operation.

On the other hand, there is document CN 203237227 also related to fuel pumps, which teaches a mobile fuel station, which is formed by a fuel room and an office room; a fuel dispenser and two manual dispensers are disposed in the fuel room; a gear pump, a flow meter and a filter are arranged on one side of the office room; a first valve is mounted on the outer wall of the office room and connected to the gear pump; the gear pump is connected to a pipeline carrying fuel by means of a second valve and is connected to the fuel pipeline by means of a third valve, the filter and the flow meter, which are disposed sequentially; the fuel pipeline penetrates through the office room to be connected with a first tank interface and a second fuel tank interface through a first branch and a second branch. The fuel station can be used as a business service station, and can also be used to manage and handle the daily fuel for fleet management in a company.

However, it can be clearly seen that the fuel supplying system described in this prior art has the disadvantage that it requires a communication with cables between the pump and the central station, which is undesirable because the cables may be subject to manipulations by third parties and the information being handled can be compromised, and at the same time it does not have a series of sensors that allow constantly monitoring of the supplying system.

Finally, there is document CA 2838105 which refers to a method for facilitating the purchase of fuel from a fuel pump by means of a driver using a credit instrument to make a fuel request for a vehicle forming part of a fleet of vehicles belonging to a company having fleet management software, wherein the method comprises having the driver enter the vehicle information and driver information through the fuel pump in response to a credit request to purchase fuel ensuring that the credit instrument has the requested credit, confirm the information of the vehicle and the driver, and if information is confirmed and ensured, authorize the fuel supply through the pump; and if there is no confirmation of the information, decline the fuel supply at the pump, where all the checking is done by means of wireless communication between the different stations and a control point where the storage of the database is held.

By virtue of the current state of the art available for fuel pumps or dispensers, it would be highly desirable to have a new pump that has some mechanism or system that allows for constant monitoring of the supply being made, especially when there are customers with fleets of vehicles, in order to be able to obtain accurate and adequate reports when required, at the same time that this pump must contain a series of sensors that ensure the operation thereof same and avoid inconveniences when doing maintenance or simply with regular use of the device.

### BRIEF DESCRIPTION OF THE INVENTION

It is therefore an object of the present invention to provide a new fuel pump which allows for better control of inventories and fuel stock without the need for additional software.

It is yet another object of the present invention to provide a fuel pump having a data transmission port.

It is further another object of the present invention to provide a fuel pump that meets the requirements of the IP65 Standard.

It is another object of the present invention to provide a fuel pump which has a plurality of sensors which do not require additional software for inventory control.

It is further another object of the present invention to provide a fuel pump which has a more secure communication module to avoid data manipulation.

It is yet another object of the present invention to provide a fuel pump that efficiently controls the fuels being dispatched and at the same time the inventory stored in the tanks, allowing control of inventory reconciliation, this being an ideal control for the validation of missing or surplus fuel, through which the quantity delivered versus the inventory is analyzed so as to control that there are no technical losses of fuel.

It is yet another object of the present invention to provide a fuel pump comprising an upper compartment provided with an electronic arrangement which is operatively connected to one or more display screens, to a printing mechanism, and to one or more flow modules; and a lower compartment provided with a hydraulic structure which is connected to one or more fuel tanks/reservoirs and to a fuel dispatch device through which the fuel, is dispatched in the vehicles; wherein the pump further comprises one or more inventory level sensors arranged in said fuel tanks/reservoirs and operatively connected with said electronic arrangement, one or more pressure and temperature sensors arranged in said fuel tanks/reservoirs and connected to said electronic arrangement a data input mechanism arranged in said upper compartment, which comprises a capacitive keyboard provided with a glass touch surface and connected to said electronic arrangement, a USB data transmission port arranged in said upper compartment and connected to said electronic arrangement, and a fleet management module connected to said electronic arrangement.

### BRIEF DESCRIPTION OF THE DRAWINGS

For greater clarity and understanding of the object of the present invention, the same has been illustrated in several figures, in which the invention has been represented in one of the preferred embodiments, all by way of example, wherein:

FIG. 1 shows a perspective view taken from a side of the fuel pump according to the present invention;

FIG. 2 shows a perspective view taken from the other side of the fuel pump according to the present invention;

FIG. 3 shows a perspective and exploded view of the fuel pump of the present invention;

FIG. 4 shows a side view of the pump of the invention;

FIG. 5 shows a perspective view of the hydraulic structure according to the present invention;

FIG. 6 shows a perspective view of the pump of the invention, taken from the same side as FIG. 2 and showing some of the components housed within the upper compartment;

FIG. 7 shows a detailed view of the visible components of FIG. 6 which are housed within the upper compartment according to the invention;

FIG. 8 shows a perspective view of the pump of the invention, taken from the same side as FIG. 1 and showing the other part of the components housed within the upper compartment;

FIGS. 9A and 9B show a detailed view of the visible components of FIG. 8 which are housed within the upper compartment, according to the inventions;

FIG. 10 shows a block diagram of the pump according to the present invention;

FIG. 11 shows a connection diagram of the pump according to the invention;

FIG. 12 shows a connection diagram of one of the flow modules of the pump of the present invention;

FIG. 13 shows a hydraulic diagram of the pump of the present invention.

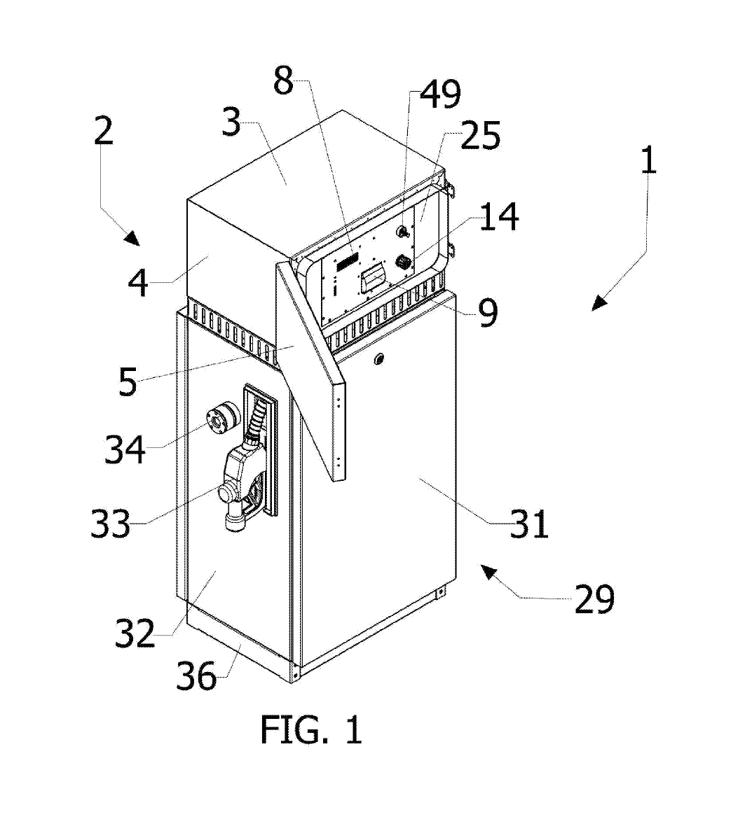

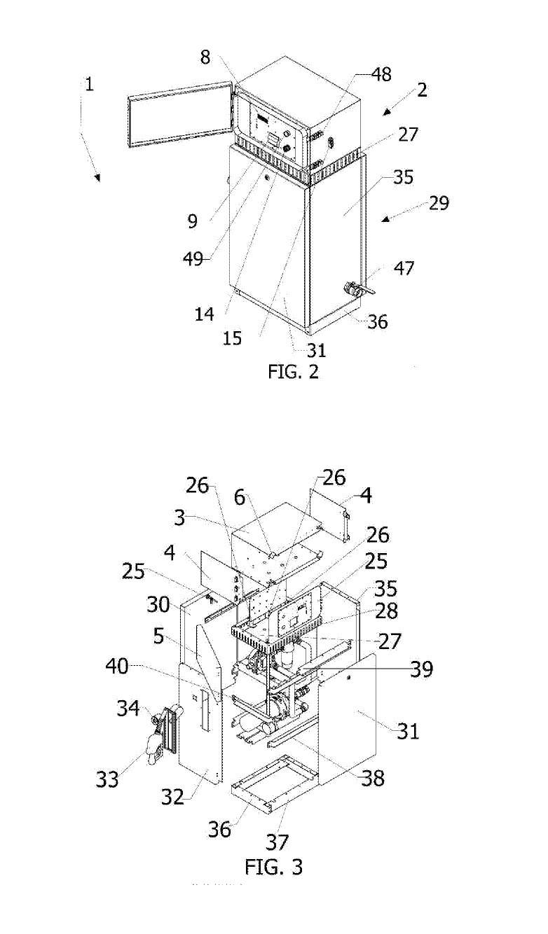

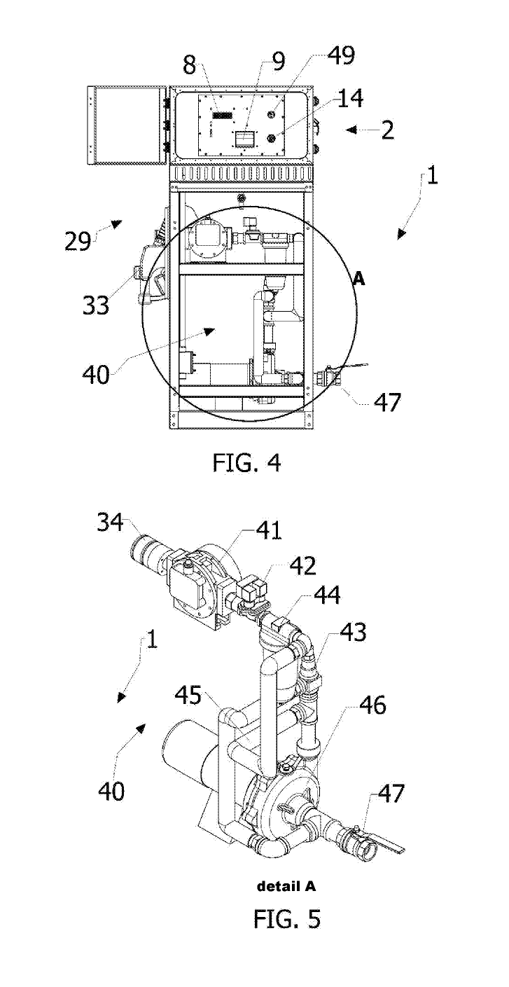

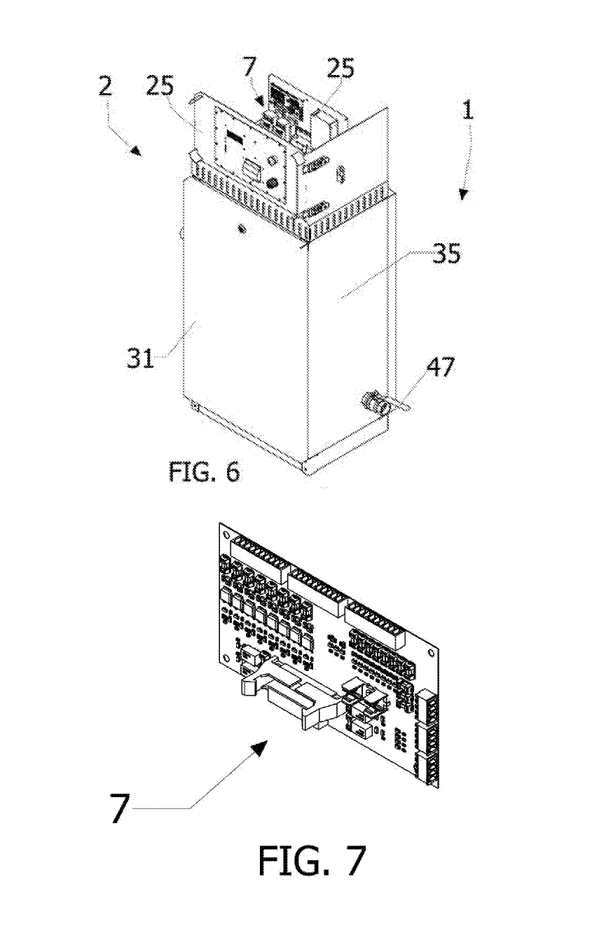

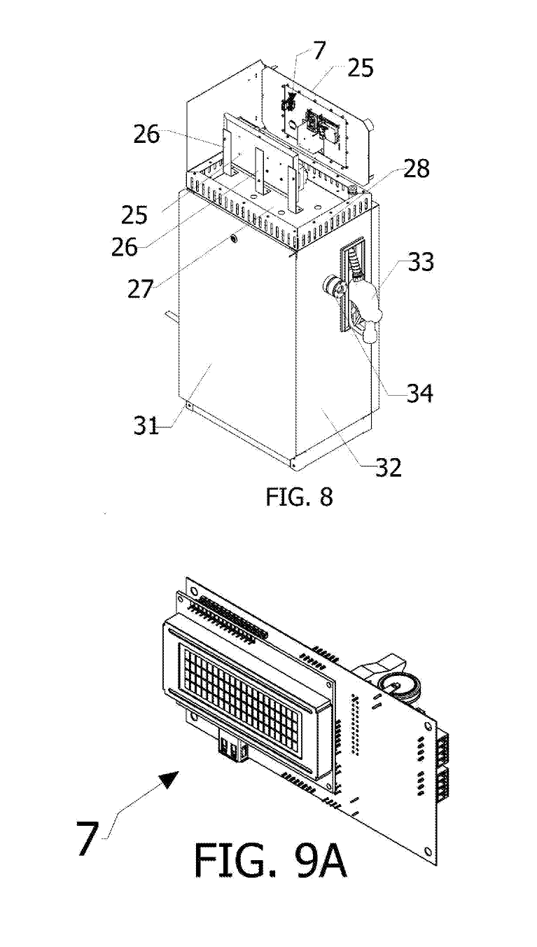

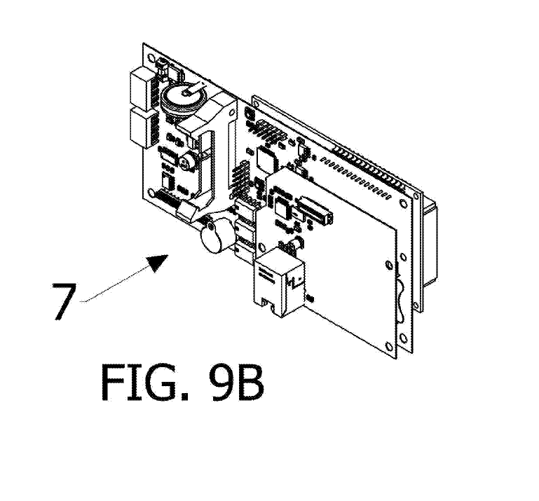

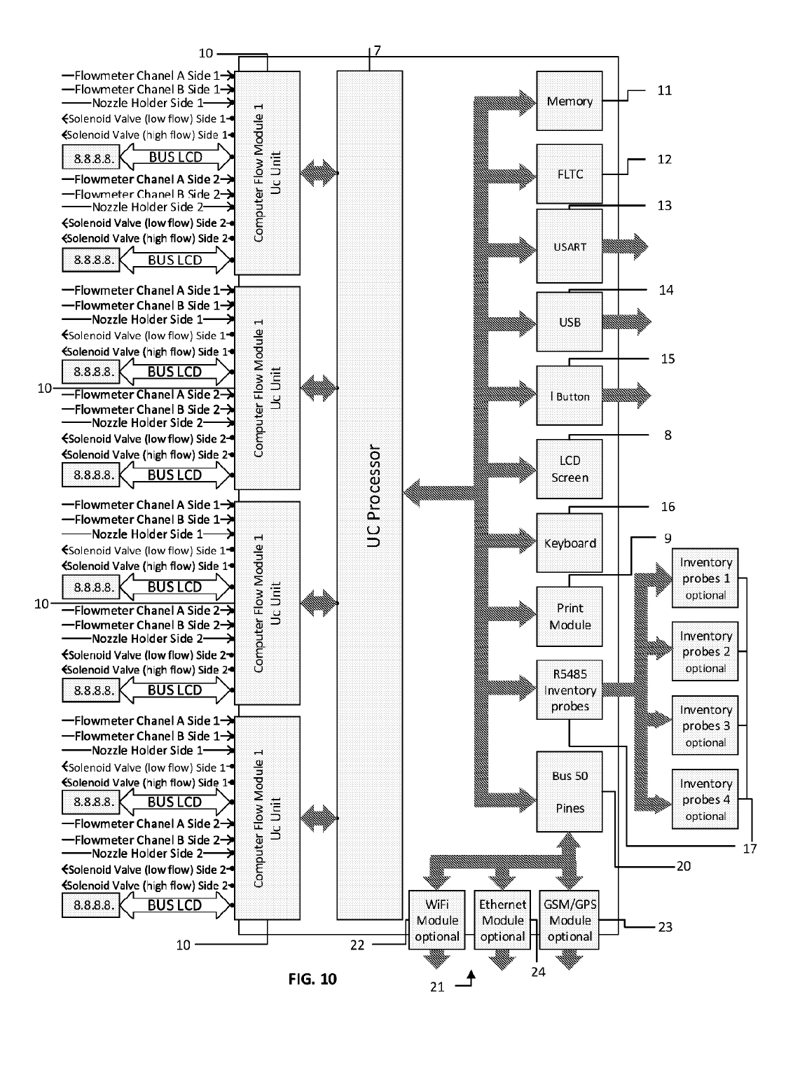

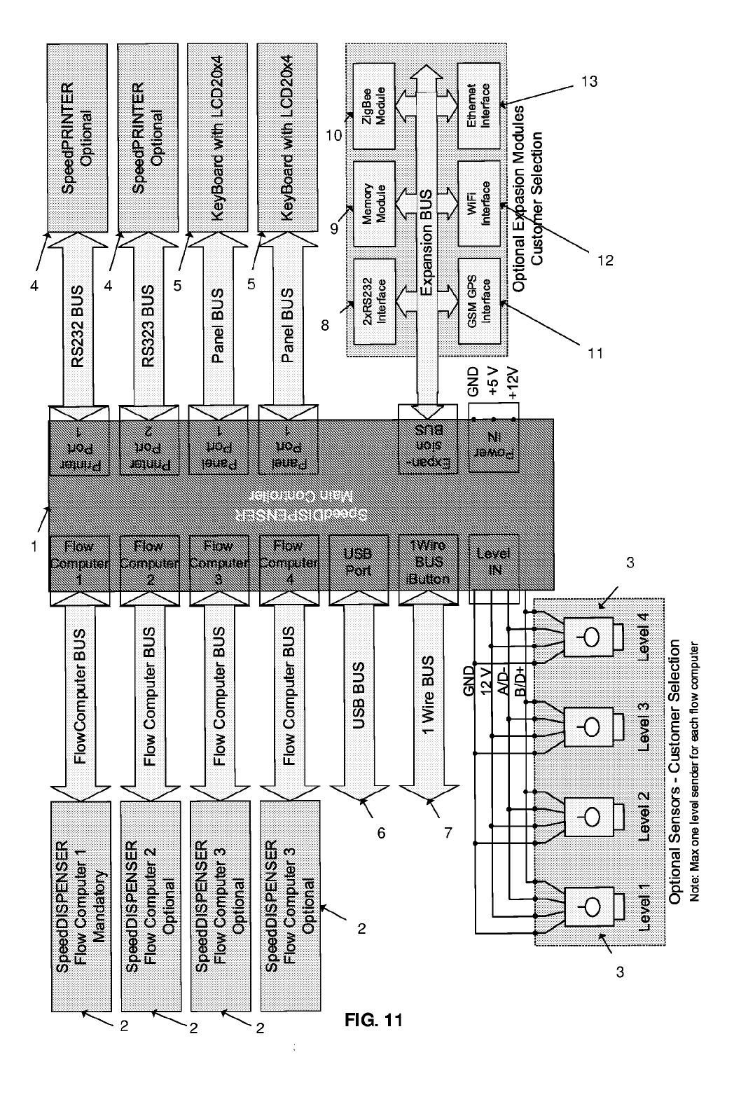

### DETAILED DESCRIPTION OF THE INVENTION

Referring now to the figures, it is seen that the invention consists of a new fuel pump which is indicated by the general reference 1. Said pump 1 comprises an upper compartment 2 which has a top drawer 3, several side covers 4 and a top front cover 5, said upper drawer 3 being provided with respective curved supports 6. Likewise, said upper compartment 2 houses an electronic arrangement 7, FIG. 10, comprising a central unit processor 7 connected to one or more display screens 8, to a printing mechanism 9, to one or more flow modules 10, to a data storage module 11, to a real-time clock RTC 12 that guarantees a reliable time base for everything related to dates and times, to a general purpose USART 13 serial communication port that allows connecting accessories such as barcode readers, external printers, information screens or any other device with serial connection capacity, to a USB transmission data port 14, to a fleet management module 15, to a data input mechanism 16, to one or more inventory level sensors 17, to one or more temperature 18 and pressure 19 sensors and a pin bus 20 which are connected to a communication module 21 which may comprise a wireless communication module via Wi-Fi 22 or GSM 23, or a communication module via Ethernet 24, by means of which emails or text messages may be sent with management reports.

It is pointed out that said components are mounted on two plates 25 which are supported by respective supports 26 which are arranged in an intermediate cover 27 which has a ventilation sheet 28 which separates said upper compartment 2 from a lower compartment 29. Likewise, said display screens comprise one or more display screens for measurement of volume of the dispatched product one or more display screens for equivalence in money of the dispatched product such that the user always knows how the money equivalent of the fuel being supplied, one or more configurable display screens for price per volume unit in accordance with the needs and parameters of the fuel supply station, one or more display screens for current product levels, and one or more display screens for recharge recording. Whereas, said printing mechanism is a ticket dispenser.

On the other hand, said inventory level sensors 17 are disposed in the fuel tanks/reservoirs and comprise water level sensors and product level sensors, both of which are magnetostrictive type sensors. The use of such level sensors in conjunction with these pressure and temperature sensors allows the operation of recharge and/or leakage detection algorithms in the tank and also allow the calculation of temperature compression (CTL) and pressure compression (CPL), thus providing the dispatched gross and net volumes. In this way, said sensors 17 allow measuring the fuel inventory stored in the fuel station tanks by segmenting the amount of product (fuel) and water that exists in the tank without relying on any fuel inventory console as an additional accessory. It is pointed out that up to 4 level sensors can be connected, ensuring the control of fuel inventory of up to 4 tanks, all without requiring any additional management software or connection to any additional external platform. Also, the arrangement of the level, pressure and temperature sensors allows the control of the dispatched fuel and in turn control the inventory stored in the tanks, allowing the control of inventory reconciliation, being an ideal control for validation of missing or surplus fuel. In this way, the amount delivered versus the inventory can be analyzed and it is possible to control that there are no non-technical losses of fuel, all without requiring any additional management software or the connection to any additional external platform.

On the other hand, said data input mechanism 16 comprises a 20-key capacitive keyboard with a glass touch surface, allowing high performance and improved durability that prevents the keys from fading and eventually erasing the letter or number that was printed there, which is a problem present in the current pumps due to the constant use thereof. On the other hand, said fleet management module 15 allows an adequate management or handling when there are clients having a plurality of vehicles and a permanent control over them is required. This fleet management module allows the storage of electronic identifiers with restrictions by dispatch and by volume quantity dispatched in one day and the respective report can be generated, according to the needs of the client. Also, this fleet management module has a system of manual acquisition by means of typing supplementary information to the register, such as an odometer or horometer, which is configurable up to 4 different fields with numerical or alphanumeric possibility. In a preferred embodiment of the invention, the fleet management module also has a series of electronic label readers, such as iButton, RF Tags or Rings, among others, where said reading is carried out wirelessly (via respective Wi-Fi or GSM modules) or wired (via a respective Ethernet module), as the case may be, in order to identify each of the electronic markers that are independently located on each vehicle that is part of the fleet. In this way, the amount of fuel per day that a vehicle can receive may be indicated, all without requiring any additional management software or connection to any additional external platform.

With respect to the data storage module 11, it may interact directly with said fleet management module 15, since the system may store all the records generated in the fleet management in said memory unit, such as the USB type memory. On the other hand, said data storage module 11 may be connected to said fleet management module 15, to said USB data transmission port 14 and to said inventory level sensors 17. On the other hand, through a handling and management mechanism it is possible to directly control and manage the pump of the invention autonomously to perform openings and closings of the operator shifts, electronic identification of the operator (vendor), where these openings and closings can be stored in storage 11, or may also be printed to have a physical control, while allowing the search of previous registries in the display module for subsequent printing.

Referring to the lower compartment 29, it has rear 30 and front 31 walls, a side wall 32 provided with respective holes for the passage of a fuel dispatch device 33 and a flow display 34, and a side wall 35 provided with a hole for the passage of a ball valve which will be described below. Said walls 30, 31, 32 and 35 are mounted on a lower support 36 which has a front lower support 37 and several inner supports 38. It is pointed out that said intermediate cover 27 is supported on respective upper supports 39 provided in the upper part of the lower compartment 29. Likewise, within said lower compartment 29 there is a hydraulic structure 40 comprising said flow display 34, an electrovalve 42, a relief valve 43, a filter 44, a hose 45 and a motor pump 46 connected to a ball valve 47 which protrudes beyond the side wall 35. It is noted that said elements are interconnected through respective pipes and elbow joints, said hydraulic structure permitting the extraction of the fuel from the tanks/reservoirs to be delivered to the vehicles through the fuel dispatch device 33 which comprises a gun 33, well known in the field of the art and that for said reason will not be described in detail. Likewise, the invention may have a traction lock 48, an on/off push button 49 and a camera system for recording photos of the pump area at the time of the transaction in order to identify the persons or vehicles that were present.

The fuel pump of the present invention is constituted and constructed in this way, which allows for a better control of the fuel inventories and stock, and a better control and management of fleets, allowing a simultaneous dispatch of up to 8 units, and which is provided with inventories of up to four tanks. Likewise, the pump has a design that complies with the IP65 Standard, which guarantees that this equipment can be installed outdoors, thereby differentiating it from other electronic pumps in the market. In addition, the fuel pump of the invention allows constant monitoring of the supply being made, especially when there are customers that have fleets of vehicles, in order to obtain accurate and adequate reports when required.

It is noted that although in the description of FIG. 11 reference numbers from 1 to 13 shall be used, they indicate parts that are independent and different from those indicated with the same references used in the previous Figures. According to FIG. 11, a diagram basically representing the main controller 1 SpeedDISPENSER (SpeedDISPENSER Main Controller) may be seen, which is the central processing unit, which is capable of controlling up to four “SpeedDISPENSER Flow Computer” 2 responsible for measuring and displaying the dispatched volumes; up to four magnetostrictive level probes 3, for the measurement of the level of fuel and water present In the tanks associated to the dispenser; up to two printers 4, which allow printing of transaction receipts, sales balances by period of time, alerts, tank inventory; up to two typing and printing visualization panels 5, panel for visualization of the control menu and interaction of vendor with the system, which allows to view customer information, enter control data, as mileage and/or internal number of the vehicle, defining de amount and product to be dispensed by volume or money. In addition, it shows the USB for connection of USB memories 6 to load data such as client lists, list of identifiers, system configuration, system update, it also serves for downloading data such as transactions, tank-levels, sales balances, current. Likewise, it has a 1Wire bus 7 for the connection of Maxim brand iButton identifier readers, an expansion bus for peripheral installation such as: RS232 expansion interfaces 8, which allows the connection of accessories such as bar code readers, RFID tag readers, among others; memory module 9, to expand the internal storage capacity of the system; and communication modules ZigBee 10, GSM 11, Wi-Fi 12 and Ethernet 13 which enable the wireless or wired connection (as the case may be) of the pump to the control center,

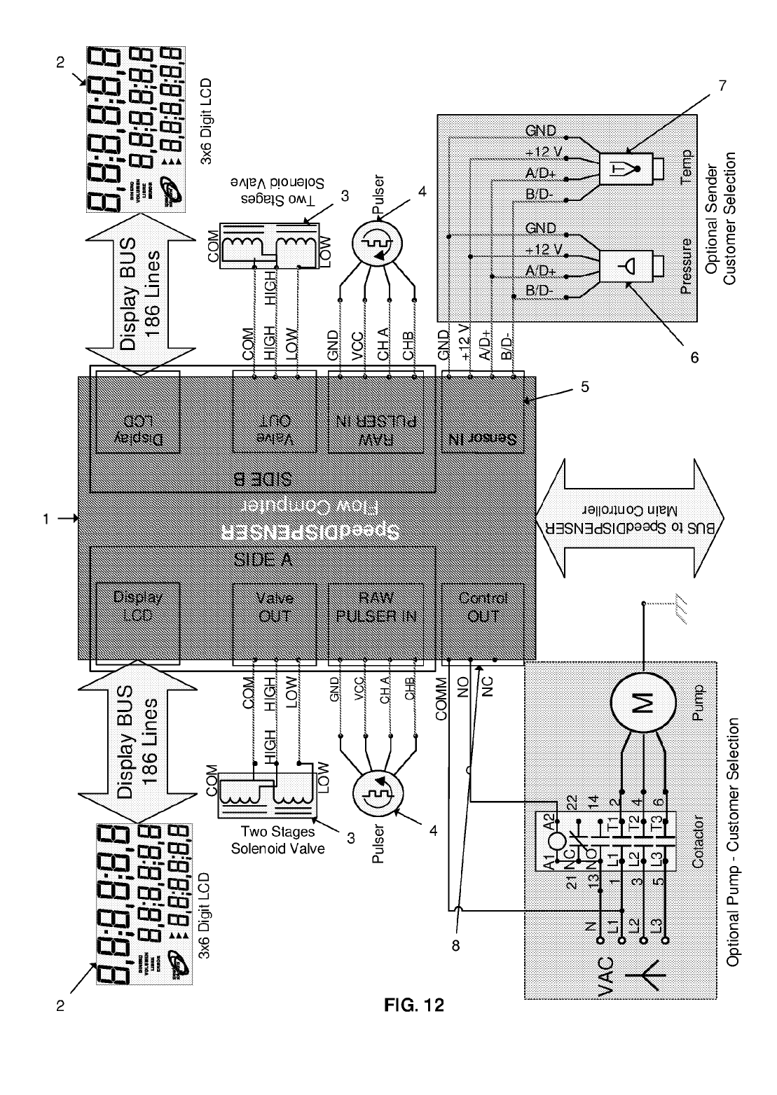

It is noted that, although in the description of FIG. 12 reference numbers from 1 to 8 shall be used, they indicate parts that are independent and different from those indicated with the same references used in the previous Figures. According to FIG. 12, there is a SpeedDISPENDER Flow Computer 1 (SpeedDISPENDER Flow Computer), which is the unit responsible for flow measurement, display of dispatched volume and calculation of the value of the dispatched product; each flow computer having the ability of autonomously controlling up to two flow measurement units (flow meters), thus having the ability to control two transactions simultaneously. Where, the “SpeedDISPENSER Flow Computer” has two buses to control up to two displays 2, which show the price per volume unit, the dispatched volume and the amount of the transaction; two preset valves 3 that allow controlling the passage of product by the measurement units; two pulse units 4 coming from the flow meters to count the dispatched volume; an RS485 (MODBUS) port 5 for the connection of pressure 6 and temperature 7 transmitters (sensors); and two dry contacts 8 for controlling the on-off of the pump (if the system is equipped with an electro-pump.)

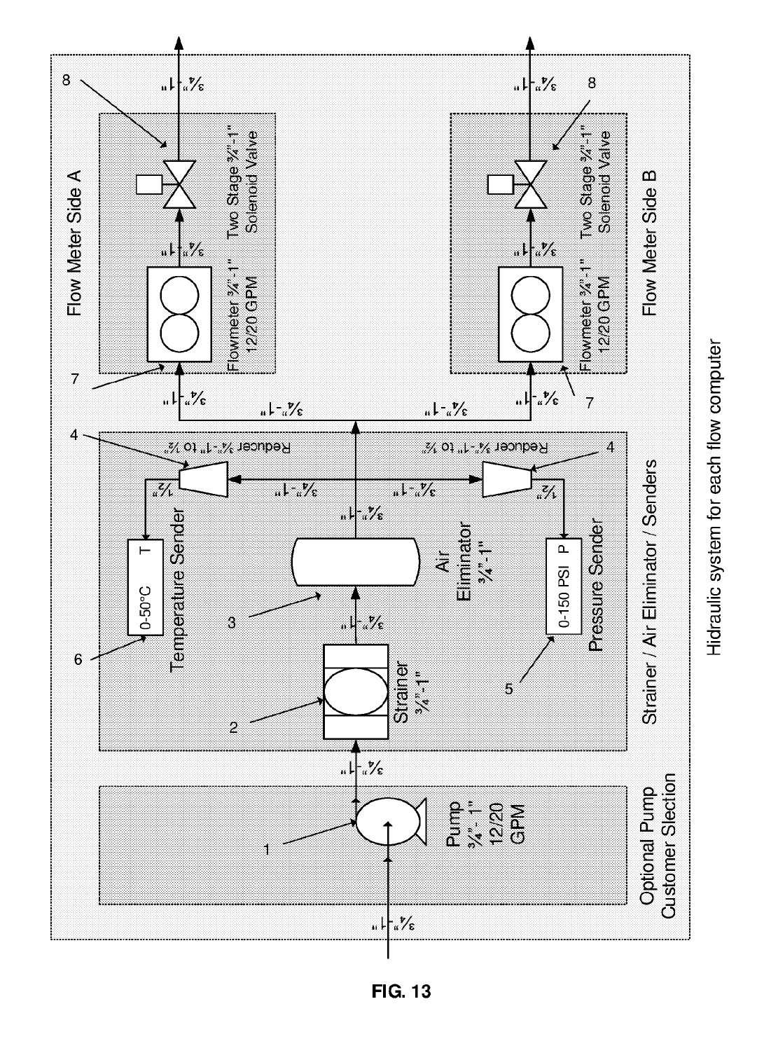

It is noted that, although in the description of FIG. 13 reference numbers from 1 to 8 shall be used, they indicate parts that are independent and different from those indicated with the same references used in the previous Figures. Thus, FIG. 13 shows a hydraulic diagram of the system, including all the hydraulic elements that make up the pump and the interconnection between them, the hydraulic system is comprised by an electro-pump (PUMP) 1 which can be optional, and serves to propel the product (Fuel) by the hydraulic system; filter (STRAINER) 2 or mesh filter to avoid the passage of large impurities by the system which could damage the flow meter; an air eliminator 3 (Air Eliminator) which can be optional is responsible for avoiding the passage of air to the flow meter to ensure that the how measurement is only counting product and not air; up to two optional ½″ couplings 4, for connection of pressure or temperature transmitters; a pressure transmitter 5 (PRESSURE SENDER), which can be optional, which allows knowing the in-line pressure to perform the pressure measurement compensation; an optional temperature transmitter 6 (TEMPERATURE SENDER), which allows knowing the in dine temperature to perform the temperature measurement compensation; up to two Flow Meters 7 (FLOWMETER) for measuring the product being dispatched; and up to two present valves 8 (TWO STAGES SOLENOID VALVES) to control product flow and ensure the exact dispatch being requested.

1. A fuel pump comprising:
An upper compartment provided with an electronic arrangement which is operatively connected to one or more display screens, to a printing mechanism, and to one or more flow modules; and
A lower compartment provided with a hydraulic structure which is connected to one or more fuel tanks/reservoirs and to a fuel dispatch device through which the fuel is dispatched in the vehicles;
Wherein the pump comprises:
One or more inventory level sensors arranged in said fuel tanks/reservoirs and operatively connected with said electronic arrangement,
One or more pressure and temperature sensors arranged in said fuel tanks/reservoirs and connected to said electronic arrangement,
A data input mechanism arranged in said upper compartment, which comprises a capacitive keyboard provided with a glass touch surface and connected to said electronic arrangement,
A USB data transmission port arranged in said upper compartment and connected to said electronic arrangement, and
A fleet management module connected to said electronic arrangement.

2. A fuel pump according to claim 1, wherein said inventory level sensors are water level sensors and product level sensors, bath of which are magnetostrictive type sensors.

3. A fuel pump, according to claim 1, wherein the fleet management module has one or more electronic label readers which can be selected from the group that consists of iButton, RF Tags or Rings, contact less cards or devices with NFC technology, said reading being wireless.

4. A fuel pump according to claims 1, wherein said fleet management module has an information keyboard supplementary to the keyboard of the data input mechanism, and comprises a configurable odometer or horometer of up to 4 different fields with numerical or alphanumeric possibilities.

5. A fuel pump according to claim 4, wherein said fleet management module has storage means, for electronic identifiers with restrictions by dispatch and by volume quantity dispatched in one day.

6. A fuel pump according to claim 1, wherein, a data storage module is provided.

7. A fuel pump according to claim 1, wherein said data storage module is connected to said fleet management module, to said USB data transmission port, to said inventory level sensors and said electronic arrangement.

8. A fuel pump according to claim 1, wherein said display screens comprise:
One or more display screens for measurement of volume of the dispatched product,
One or more display screens for equivalence in money of the dispatched product,
One or more display screens for price per volume unit,
One or more display screens for current product levels, and
One or more display screens for recharge recording.

9. A fuel pump according to claim 1, wherein there is provided a communication module which is connected to said electronic arrangement through respective pins.

10. A fuel pump according to claim 9, wherein said communication module is wireless and is selected from the group consisting of communication via Wi-Fi or GSM.

11. A fuel pump according to claim 9, wherein said communication module is via Ethernet.

12. A fuel pump according to claim 1, wherein said hydraulic structure comprises a flow display, a measurement unit a solenoid valve, a relief valve, a filter, a hose and a motor pump connected to a ball valve, the same being interconnected by respective pipes and elbow joints.
